(19) United States
(12) Patent Application Publication
(10) Pub. No.: US 2024/0162556 A1
(43) Pub. Date: May 16, 2024

(54) High-Voltage Accumulator Module Having a Multiplicity of Battery Cells

(71) Applicant: Bayerische Motoren Werke Aktiengesellschaft, Muenchen (DE)

(72) Inventors: Korbinian ANTWERPEN, Reimlingen (DE); Simon NUERNBERGER, Bad Aibling (DE)

(21) Appl. No.: 18/284,117

(22) PCT Filed: May 18, 2022
(86) PCT No.: PCT/EP2022/063367

§ 371 Date: Sep. 26, 2023

(30) Foreign Application Priority Data
Jun. 25, 2021 (DE) 10 2021 116 442.7

(51) Int. Cl. H01M 50/296; B60R 16/033; H01M 10/653; H01M 50/204; H01M 50/509; B60L 50/60

(52) U.S. Cl. CPC H01M 50/296; B60R 16/033; H01M 10/653; H01M 50/204; H01M 50/509; B60L 50/60; H01M 2220/20

(57) ABSTRACT

A high-voltage accumulator module has a multiplicity of battery cells, the battery cells being arranged in a honeycombed parallel and series connection assembly. The gaps between the battery cells are filled with a thermally and electrically conductive potting compound. The battery cells are electrically insulated with respect to the potting compound. The potting compound is connected to an energy source via electrically conductive fixing elements that protrude into the potting compound and via two pole connections in such a way that a current flow through the potting compound which is as homogenous as possible is achieved. The two pole connections, for example in the form of metal plates, are preferably fastened to the potting compound over a large surface area and in close electrical contact therewith by way of the fixing elements. The fixing elements may protrude as deep as possible into the potting compound in the form of strips or pins and may contain barbs.

### BACKGROUND AND SUMMARY

The present invention relates to a holding device for battery cells, a multiplicity of which are installed to form a battery module of a high-voltage storage device, in particular for an electric vehicle or for a hybrid vehicle.

High-voltage storage devices, also referred to as drive batteries or rechargeable batteries, are known for providing electrical energy for supplying electrical drives of vehicles. A comparatively high voltage of 400-800 V, for example, is required for supplying electrical drives of vehicles. Nowadays such high-voltage storage devices are generally not constructed as monoblocs, but rather modularly from a multiplicity of battery cells; i.e. a high-voltage storage device in general consists of a plurality of modules each consisting of closely “packed” cells interconnected in parallel and serially, often in a honeycomb structure (also called “honeycomb”). This increases the freedom of design and makes it possible to use comparatively cost-effective standard cells that can be produced as mass-produced products, instead of individual custom-made items. The number of battery cells used is directly correlated with the range of the electric or hybrid vehicles. In practice, for example, round cells or prismatic battery cells are used as battery cells for the high-voltage storage devices.

The prior art discloses a large number of combinations of different technologies in the context of lithium-ion battery systems with regard to cell temperature regulation, supporting structures for the battery housing, and various safety elements.

In present-day high-voltage storage structures of electric vehicles, cells are cooled and/or heated by means of the following conditioning systems, for example.

1. Cooling coils with cooling liquid between the cells, on the cells or below the cells.

2. Heat-conducting plates with link to liquid cooling between the cells, on the cells or below the cells.

3. Electrical heating film structures between the cells, on the cells or below the cells.

4. Cells around which liquid flows in the form of “immersion cooling” or “immersion heating”.

In all these structures, the cooling liquid can also be heated up by means of a heating facility in order to achieve heating of the cells.

The performance of lithium-ion rechargeable batteries is temperature-dependent. Particularly in the case of cells with high energy densities or with manganese-rich cell chemistry or with the use of solid electrolytes (“all solid state”), this temperature dependence of the performance becomes more and more pronounced: the lower the cell temperature, the lower the accessible performance. Traditional heating concepts require a high integration outlay in order to bring the heating energy to the cell as closely and efficiently as possible. In this case, the cooling concept usually clashes with the required installation space of the heating structure.

In modern high-voltage storage structures, round cells, in particular, are inserted into placeholder frames in order then to connect the latter further to form a so called “battery pack” or high-voltage storage module. This structure is colloquially also referred to as a “honeycomb” (honeycomb structure).

The invention is based on the object of providing a holding device for battery cells which is improved with regard to the temperature problem mentioned above.

The invention is achieved with the features of the independent claims. The dependent claims relate to advantageous developments and advantageous embodiments.

The invention relates to a high-voltage storage module comprising a multiplicity of battery cells, wherein the battery cells are arranged in a honeycombed parallel and serial interconnection assemblage (e.g. “honeycomb”). In a module, for example, in each case five cells are interconnected in parallel and twelve of these parallel bundles of five are interconnected serially.

The interspaces between the battery cells are filled with a thermally and electrically conductive potting compound. The electrical resistance of the potting compound is chosen for example such that when current flows or upon connection to an energy source, a heating power of 10-60 W (preferably 20-40 W) per cell arises.

The battery cells are electrically insulated with respect to the potting compound. The potting compound is connected to an energy source via electrically conductive fixing elements projecting into the potting compound and via two pole connections in such a way that a current flow through the potting compound, which is as homogeneous as possible, is attained.

Preferably, the two pole connections, for example in the form of metal plates, are secured to the potting compound in close electrical contact over a large surface area by means of the fixing elements.

The fixing elements can project in striplike or pinlike fashion as deep as possible into the potting compound and, preferably, additionally have barbs.

The invention is based on the following considerations.

The basic concept of the invention is to connect a high-voltage storage module (preferably in the form of a “honeycomb”) to an electrical energy source by means of an electrically conductive and heat-conducting potting compound around the battery cells of the module (honeycomb) and by means of an electrical link attached to the potting compound, in particular an enlarged surface area of the pole terminals, the honeycomb being electrically heated by means of the current from said energy source.

The honeycomb is advantageously configured and connected to the energy source in such a way as to enable a current flow through the honeycomb, or through the potting compound in the honeycomb, that is as homogeneous as possible in order to attain uniform heating of the cells. This is effected by way of an electrical link, as illustrated in the exemplary embodiments in accordance with the drawing, in particular over the entire width of the honeycomb and by means of electrically conductive fixing elements in the potting compound of the honeycomb. In this case, the connection is effected over the largest possible surface area via a highly conductive metal (e.g. aluminum, copper, nickel) in order to ensure a current distribution over the entire connection width and simultaneously into the depth of the honeycomb.

In this case, the potting compound of the honeycomb can enclose either the entire cell or only part of the cell. A high-voltage storage device can also consist of a plurality of honeycombs or modules according to the invention which are electrically connected. In this case, the energy source can be the module to be heated or the entire high-voltage storage device to be heated. An external energy source situated outside the vehicle, such as a charging point for electric automobiles, for example, can also constitute the energy source in this case.

When selecting the material for the potting compound of the module or of the honeycomb, the following material groups are considered:
carbon-doped plastic and thus conductive plastic,
metal-doped plastic and thus conductive plastic,
silicon-doped plastic and thus semiconductor-enabled plastic,
conductive metals such as iron, aluminum, nickel, copper

For all the material groups it is necessary to ensure that the cells are insulated toward the material. According to the invention, the cavities between the “packed” insulated battery cells are filled with a thermally and electrically conductive potting compound.

The invention is described below on the basis of preferred exemplary embodiments with reference to the drawings. The illustrations in the figures should be understood as purely schematic.

### BRIEF DESCRIPTION OF THE DRAWINGS

FIG. 1 schematically shows a plan view of battery cells which are “packed” in a honeycomb structure (“honeycomb”) and the interspaces between which are filled with a potting compound according to an embodiment of the invention;

FIG. 2 schematically shows a side view of the “honeycomb” in accordance with FIG. 1;

FIG. 3 shows schematically and in an enlarged view a first alternative for the advantageous configuration of the electrically conductive fixing elements for connecting the potting compound to the pole connections;

FIG. 4 shows schematically and in an enlarged view a second alternative for the advantageous configuration of the electrically conductive fixing elements;

FIG. 5 shows schematically and in an enlarged view a third alternative for the advantageous configuration of the electrically conductive fixing elements;

FIG. 6 shows schematically and in an enlarged view a fourth alternative for the advantageous configuration of the electrically conductive fixing elements;

FIG. 7 shows schematically and in an enlarged view a fifth alternative for the advantageous configuration of the electrically conductive fixing elements; and

FIG. 8 shows schematically and in an enlarged view a sixth alternative for the advantageous configuration of the electrically conductive fixing elements.

### DETAILED DESCRIPTION OF THE DRAWINGS

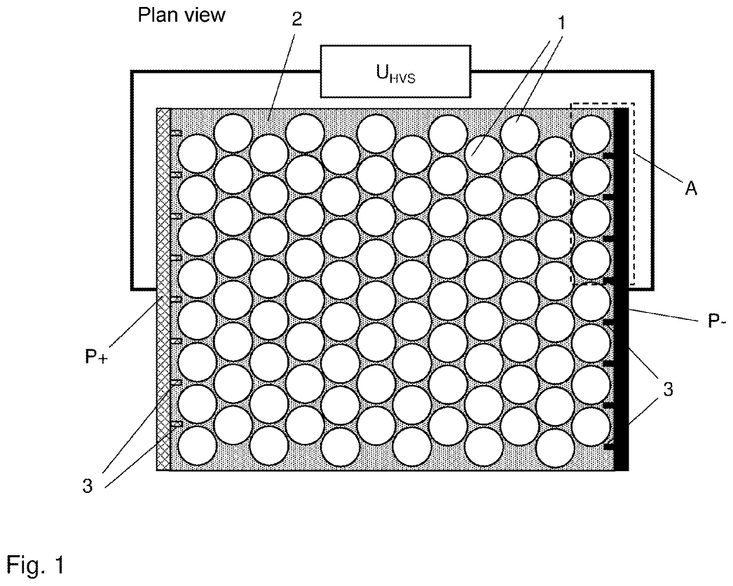

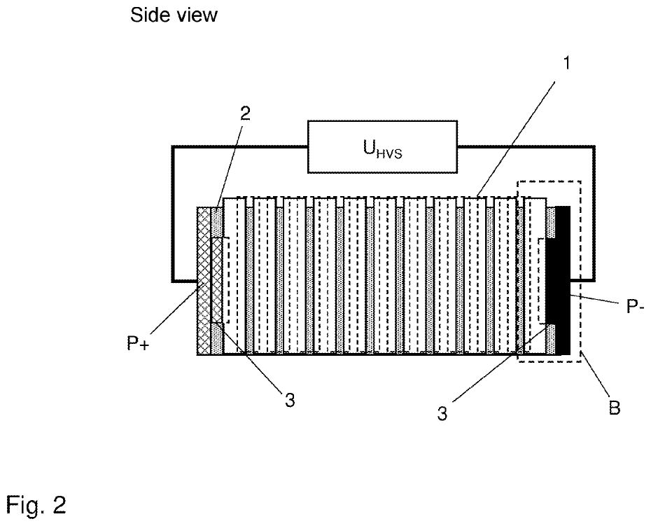

FIG. 1 shows a plan view, and FIG. 2 a side view, of a high-voltage storage module in the form of a “honeycomb” comprising a multiplicity of insulated (here round) battery cells 1.

The higher the thermal conductivity of the potting compound 2, the better and the more homogeneous the heat transfer between the cells 1. The cells 1 are packed and contacted in a so-called P-assemblage (i.e. interconnected in parallel and serially).

The battery cells 1 are arranged in a honeycombed structure, the interspaces between them being filled with a thermally and electrically conductive potting compound 2. The battery cells 1 are electrically insulated with respect to the potting compound 2 for example by means of an electrically nonconductive housing or by means of a corresponding coating (not illustrated in more specific detail here). The potting compound 2 is connected to an energy source UHVS via electrically conductive fixing elements 3 projecting into the potting compound and via two pole connections P+ and P− in such a way that a current flow through the potting compound 2 which is as homogeneous as possible is attainable. The energy source is preferably the module itself.

The two pole connections P+ and P− are contacted with the potting compound 2, which forms a three-dimensional body, over a large surface area and in a manner situated opposite one another. In FIGS. 1 and 2, the three-dimensional body is preferably a parallelepiped, and the two pole connections P+ and P− here are contacted with two opposite walls of the parallelepiped preferably over the entire surface area.

The fixing elements 3 are inseparably attached to the two pole connections P+ and P−. The two pole connections P+ and P− are secured to the potting compound 2 by means of the fixing elements 3.

It is particularly advantageous to simultaneously use the fixing elements 3 both as securing means and as homogeneous current distribution means within the potting compound 2.

Preferably, the two pole connections P+ and P− and also the fixing elements 3 have a greater electrical conductivity than the potting compound 2. For this purpose, the two pole connections P+ and P− and the fixing elements 3 can consist of conductive metal, and the potting compound 2 can consist of doped semiconductor material.

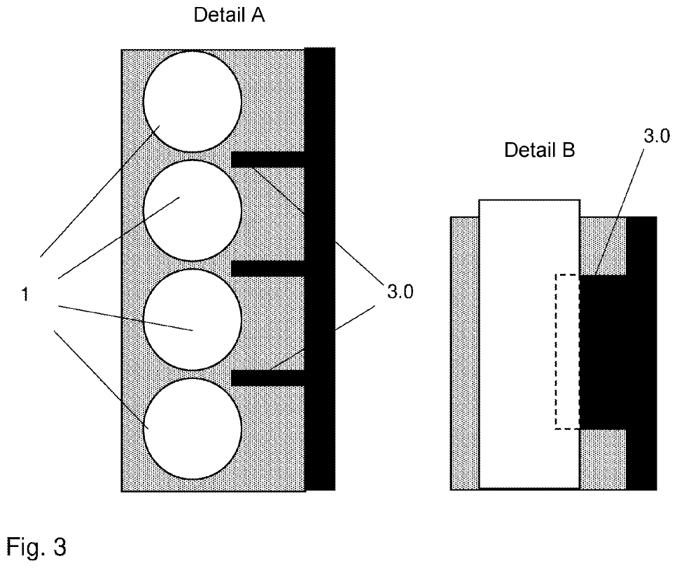

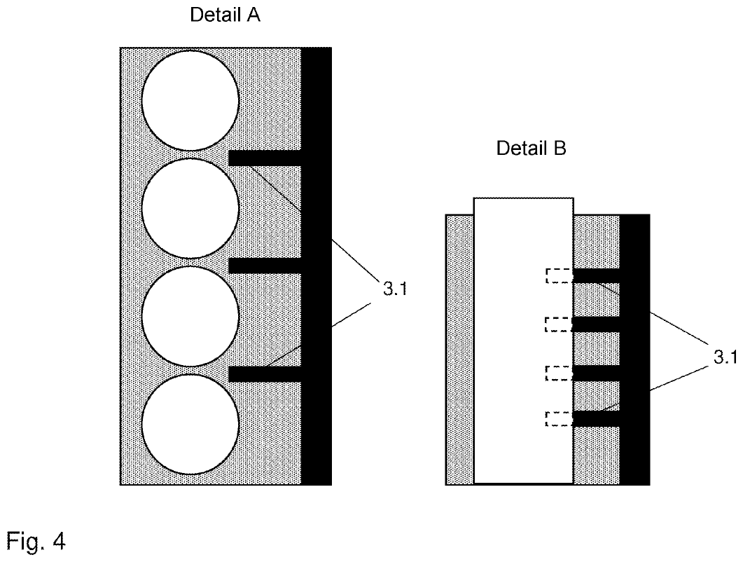

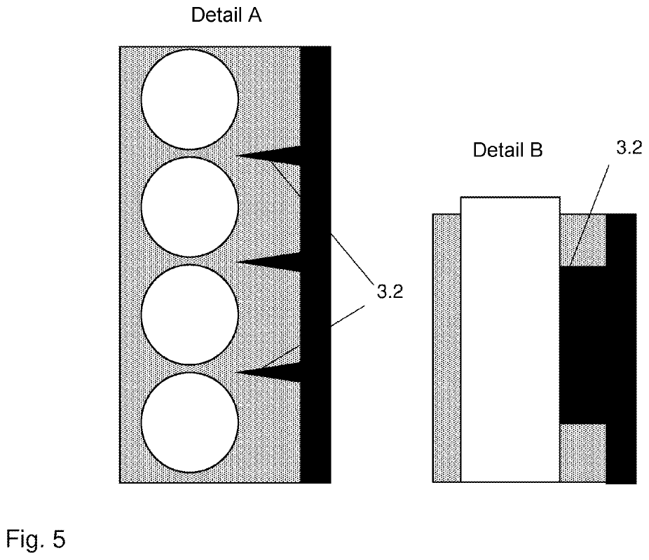

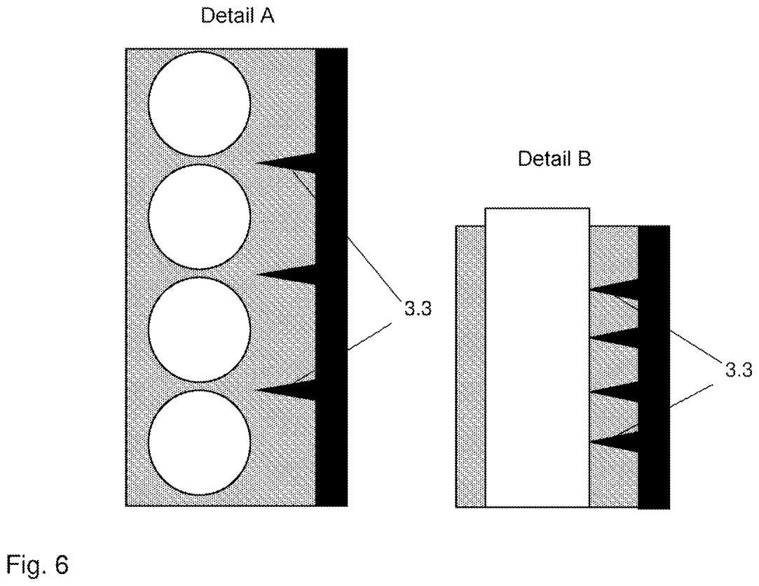

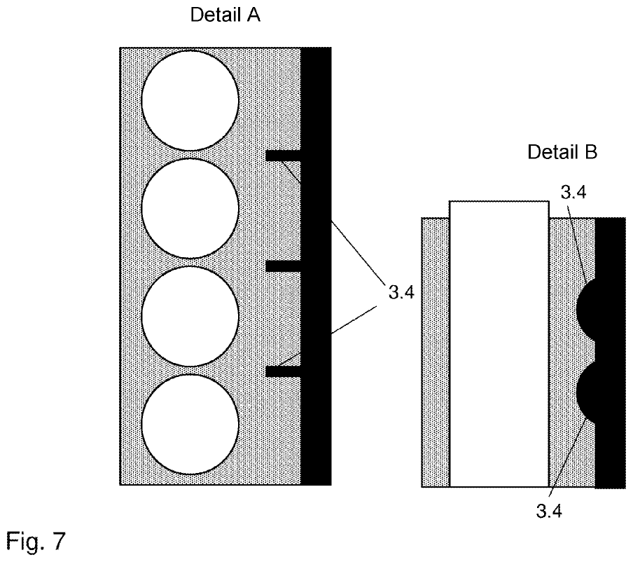

FIGS. 3 to 8 show possible detailed configurations of the fixing elements 3 as an enlargement (3.0) of the details A and B from FIGS. 1 and 2 and also various further advantageous alternatives 3.1, 3.2, 3.3 and 3.4:

The fixing elements 3.1, 3.3 and 3.4 are substantially pinlike (in the broadest sense for example also groovelike) and preferably embedded at uniform distances and/or as deep as possible in the potting compound 3.

The fixing elements 3.0 and 3.2 are substantially striplike and preferably embedded as deep as possible in the potting compound 3.

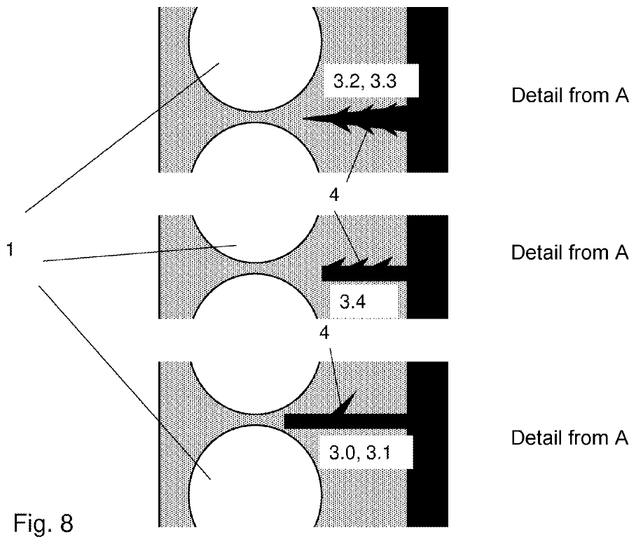

FIG. 8 shows exemplary fixing elements 3 having barbs 4 for strengthening the securing.

1.-10. (canceled)

11. A high-voltage storage module, comprising:
a multiplicity of battery cells, the battery cells being arranged in a honeycombed parallel and serial interconnection assembly;
a thermally and electrically conductive potting compound filling interspaces between the battery cells, the battery cells being electrically insulated with respect to the potting compound; and
electrically conductive fixing elements and two pole connections by which the potting compound is connected to an energy source, the electrically conductive fixing elements protruding into the potting compound, wherein the connection is such that a homogeneous current flow through the potting compound is attainable.

12. The high-voltage storage module according to claim 11, wherein
the two pole connections are contacted with the potting compound, which forms a three-dimensional body, over a large surface area and in a manner situated opposite one another.

13. The high-voltage storage module according to claim 12, wherein
the three-dimensional body is a parallelepiped, and
the two pole connections are contacted with two opposite walls of the parallelepiped over at least almost the entire surface area.

14. The high-voltage storage module according to claim 11, wherein
the fixing elements are inseparably attached to the two pole connections and the two pole connections are secured to the potting compound via the fixing elements.

15. The high-voltage storage module according to claim 11, wherein
the two pole connections and the fixing elements have a greater electrical conductivity than the potting compound.

16. The high-voltage storage module according to claim 11, wherein
the two pole connections and the fixing elements are made of conductive metal and the potting compound is made of doped semiconductor material.

17. The high-voltage storage module according to claim 11, wherein
the fixing elements are substantially pin-shaped.

18. The high-voltage storage module according to claim 11, wherein
the fixing elements are substantially strip-shaped.

19. The high-voltage storage module according to claim 11, wherein
at least one fixing element of each pole connection has at least one barb.

20. A vehicle comprising a high-voltage storage module according to claim 11.
